(19) United States
(12) Patent Application Publication
(10) Pub. No.: US 2018/0146330 A1
(43) Pub. Date: May 24, 2018

(54) CONTEXT-AWARE CHECKLISTS

(71) Applicant: ENT. SERVICES DEVELOPMENT CORPORATION LP, Houston, TX (US)

(72) Inventors: Jonathan GIBSON, Austin, TX (US); Clifford Allan WILKE, Herndon, VA (US); Joseph MILLER, Herndon, VA (US)

(73) Assignee: ENT. SERVICES DEVELOPMENT CORPORATION LP, Houston, TX (US)

(21) Appl. No.: 15/567,952

(22) PCT Filed: Apr. 24, 2015
(86) PCT No.: PCT/US2015/027474

§ 371 Date: Oct. 19, 2017

(51) Int. Cl. H04W 4/021; G06Q 10/06; H04W 4/024; G05B 13/02

(52) U.S. Cl. CPC H04W 4/021; G05B 13/0265; H04W 4/024; G06Q 10/06

(57) ABSTRACT

In examples provided herein, a method for providing a digital context-aware checklist includes calling a geoboundary package to determine whether the user is within a geoboundary of a first location of a first schedule item on a schedule for the user. The method notifies the user of arrival upon determining the user's networked device is within the geoboundary of the first location and calls a checklist package to provide a checklist of items to be performed at the first location. A level of granularity of the checklist items is based on an experience level of the user. Further, upon request from the user via the user's networked device for information pertaining to one of the items of the checklist, the method calls a supporting information package to provide supporting information to the user. The supporting information is selected based on the experience level of the user.

### BACKGROUND

Checklists of tasks and/or procedures are used by enterprises to ensure that no items are omitted by the person performing the tasks and procedures. Further, by using a checklist, tasks and procedures are performed consistently by different employees. Checklists may be printed out on sheets of paper and used manually with a clipboard and writing utensil. Alternatively, electronic checklists may be implemented on mobile devices in the form of a PDF (portable document format) document or other type of word processing document.

### BRIEF DESCRIPTION OF THE DRAWINGS

The accompanying drawings illustrate various examples of the principles described below. The examples and drawings are illustrative rather than limiting.

FIG. 1 depicts an example environment in which a digital context-aware platform (DCAP) may be implemented, where the digital context-aware platform provides a context-aware checklist experience to a user via networked devices.

FIG. 2A depicts a schematic illustration of the operation of an example checklist experience device in a digital context-aware platform providing a checklist experience to networked devices of a user.

FIG. 2B depicts a block diagram of example components of a digital context-aware platform.

FIG. 3A depicts a block diagram of example components of a networked device through which a user may request and receive a schedule, checklist and information pertaining to steps of the checklist from a DCAP.

FIGS. 3B and 3C depict block diagrams depicting an example memory resource and an example processing resource for a networked device.

FIG. 4 depicts a flow diagram illustrating an example process of providing a context-aware checklist experience to a user.

FIGS. 5A-5C depict a flow diagram illustrating an example process of providing a context-aware checklist experience to a user.

FIG. 6 depicts an example system including a processor and non-transitory computer readable medium of a digital context-aware platform.

FIG. 7 depicts an example system including a processor and non-transitory computer readable medium of a digital context-aware platform.

### DETAILED DESCRIPTION

As technology becomes increasingly prevalent, it can be helpful to leverage technology to integrate multiple devices, in real-time, in a seamless environment that brings context to information from varied sources without requiring explicit input. Various examples described below provide for a digital context-aware platform (DCAP) that may aggregate experience data for a user from different sources, and based on the aggregated data, provide a context-aware checklist to a user for performing tasks. Non-limiting examples of checklists may include maintenance procedures for a piece of machinery or repair procedures for an object. In some implementations, the DCAP may receive location information for the user, and based on the location information, provide turn-by-turn directions to the user to the site where a checklist should be used. The granularity of the items or steps in the checklist may be based upon a level of experience of the user. Further, additional information may be provided by the DCAP when requested by the user, where the additional information is selected based upon the experience level of the user.

As used herein, the terms DCAP experience and experience are used interchangeably and are intended to mean the interpretation of multiple elements of context in the right order and in real-time to provide information in a seamless, integrated, and holistic fashion. In some examples, an experience or DCAP experience may be provided to one or more networked devices of a user of a checklist.

The DCAP experience is created through the interpretation of one or more packages. Packages may be atomic components that execute functions related to devices or integrations to other systems. As used herein, the term package is intended to mean components that capture individual elements of context in a given situation. In some examples, the execution of packages provides an experience. For example, a checklist package may provide to a user a checklist of items to be performed at a particular location, and a supporting information package may provide to the user information pertaining to one of the items of the checklist, such as videos, schematics, and instructions.

In some examples, the DCAP includes a checklist experience that may be provided to a user of a checklist, and the platform may include a plurality of packages that are accessed by the experience device to provide the experiences. The packages may, in turn, access various information from a user or other resources and may call various services, as described in greater detail below. As a result, the user may be provided with contextual information seamlessly with little or no input from the user. The DCAP is an integrated ecosystem that can automatically bring context to information. For example, the DCAP can select and provide information about an item in a checklist without input from the user, where the selected information is based on the experience level of the user, and the experience level of the user may be determined from other sources besides the user.

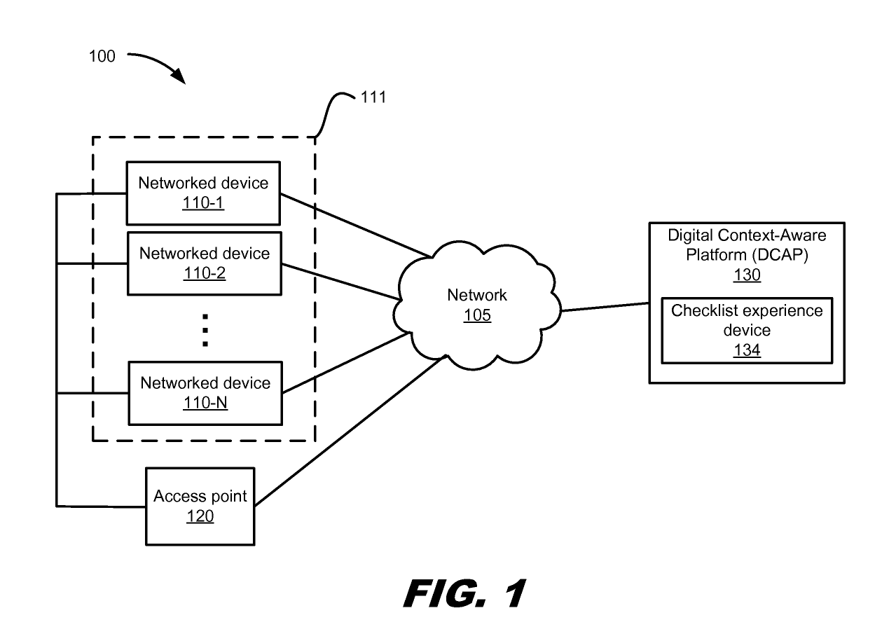

FIG. 1 depicts an example environment 100 in which a digital context-aware platform (DCAP) 130 may be implemented. The DCAP 130 may include an experience device, such as a checklist experience device 134 that calls various packages to execute functions to provide a checklist experience to a checklist user. As shown in FIG. 1, the DCAP 130 may communicate via a network 105 with a user's networked devices 110 and an access point 120 (only one is shown in FIG. 1 for clarity). The network 105 may be any type of wire or wireless network, such as the Internet, or an intranet.

The checklist experience device 134 of the DCAP 130 may provide a checklist to a user, where the granularity of the items of the checklist is based upon the experience level of the user. The checklist experience device 134 may also select and provide additional information, such as explanatory videos, pertaining to one of the checklist items based upon the experience level of the user.

Networked devices 110 may include any number of portable devices associated with a user that has a processor and memory and is capable of communicating wirelessly by using a wireless protocol, such as WiFi or Bluetooth. Examples of networked devices include a smartphone, tablet, laptop, smart watch, electronic key fob, activity tracking devices, smart glass, and any other device or sensor that can be attached to or worn by a user. In some implementations, a user's networked devices are configured to communicate with each other, for example, as indicated by networked device communication network 111 in FIG. 1.

Access point 120 may be a standalone access point device that transmits and receives data and connects networked devices 110 to other networked devices 110 and the DCAP 130. In some implementations, the access point 120 may be embedded in another device, for example, a printer. The access point 120 may include a processor and memory configured to communicate with the device in which it is embedded and to communicate with the DCAP 130 and/or networked devices 110 within wireless communication range. While only one access point 120 is shown in the example of FIG. 1 for clarity, multiple access points 120 may be located within wireless communication range of the networked devices 110 associated with a user.

Additionally, while in the example of FIG. 1, the DCAP 130 is shown as an independent element, the DCAP 130 may be implemented in a single device or distributed across multiple devices, including one or more of the networked devices 110.

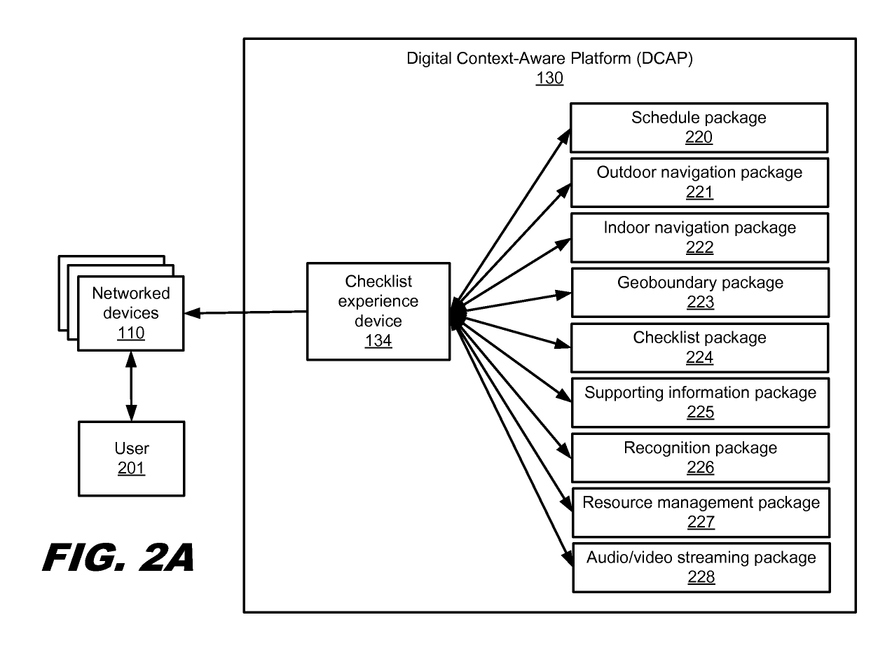

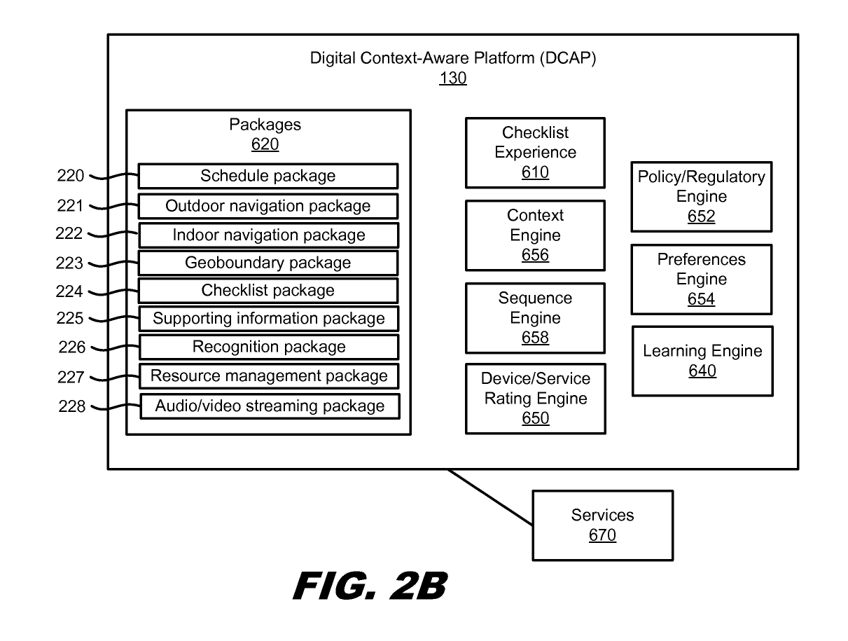

FIG. 2A depicts a schematic illustration of the operation of an example digital context-aware platform 130 providing a checklist experience to a user 201 via one or more of the user's networked devices 110. In the example of FIG. 2A, the checklist experience device 134 may call one or multiple packages, such as schedule package 220, outdoor navigation package 221, indoor navigation package 222, geoboundary package 223, checklist package 224, supporting information package 225, recognition package 226, and resource management package 227, to perform their respective functions so that a checklist experience may be provided to the user 201. The checklist experience device 134 may represent any circuitry or combination of circuitry and executable instructions to provide an experience to the user 201, and each package may represent any circuitry or combination of circuitry and executable instructions to perform the package's function.

In the example of FIG. 2A, the schedule package 220 may be called to provide to the user a schedule which includes a time and a corresponding location for each schedule item on the schedule. The schedule package 220 may be triggered to transmit the schedule to the user upon receiving from the user initialization information including a user identification, or on-demand as conditions dictate.

The outdoor navigation package 221 may be called to provide turn-by-turn directions to the location where a checklist is to be executed. The directions may be provided to the user's preferred device, for example, as determined by the preferences engine 654, to be described below with respect to FIG. 2B. For example, the user may have transmitted initialization information for the checklist to the DCAP 130 via a smartphone networked device 110. However, if the user drives in a vehicle to a first location, the outdoor navigation package 221 may provide the turn-by-turn directions to a different, user-preferred device, such as the user's networked vehicle, as determined by the preferences engine 654 in the DCAP 130.

In some instances, the indoor navigation package 222 may be called to provide directions within an indoor site to the user. Thus, the outdoor navigation package 221 may provide directions to the user to navigate to a specific building; however, the location where the checklist is to be executed may be a machine located within a large building, for example, a manufacturing facility. In this case, the indoor navigation package 222 may provide directions within the building to the user, such as a particular floor, a particular wing of the floor, and the left or right side of the corridor where the machine is situated. The directions to the indoor site may be provided on the user's preferred device, which may be different from the user's preferred device for receiving outdoor navigation directions. For example, once the user leaves the vehicle to enter the indoor site, the user may prefer to receive indoor directions on the user's smartphone.

The geoboundary package 223 may be called to determine a geoboundary for a location where a checklist is to be performed. Further, the geoboundary package 223 may determine whether the location coordinates provided by the user's networked device 110 indicates that the user has crossed the geoboundary for the first location. The geoboundary may be a virtual boundary, for example, a circle having a 500 ft. radius around the first location, or any other shape around the first location. The user's networked device 110 may provide global positioning system (GPS) coordinates or some other location identification coordinates for the user, and the geoboundary package 223 may convert the coordinates provided by the networked device 110 into a suitable format to determine whether the user has crossed the geoboundary. The goeboundary package 223 may also notify the user of arrival at the location.

The checklist package 224 may be called to provide a checklist of items, such as tasks or procedures, to the user via a preferred networked device 110. The checklist should provide a list of tasks, where the selection of the tasks takes into account a set of experiences or capabilities for the intended user of the checklist. As different users may have different sets of capabilities for different tasks, a learning engine 640 in the DCAP (shown in FIG. 2B) may determine the skill level of the intended user based upon one or more sources, such as the configuration of the user's role as set by a manager; the job code for the employee user; social media data, such as the job description, skills, and responsibilities that are catalogued by the user's capabilities or found in social media professional sites, such as LinkedIn; and history of the user's previous usage of the DCAP checklist experience, which may include information such as the time it took the user to complete a previous checklist as compared to an average user and a rating of how well the job was performed by the user. The learning engine 640 provides information pertaining to the skill level of the intended user to the checklist package 224.

Further, the checklist provided by the checklist package 224 should take into account the levels of granularity that would be useful to the intended user. For example, if the goal is to create a peanut butter sandwich, for a user seeking to create a quick snack, the items on the checklist would not include tasks for baking the bread or making the peanut butter. However, if the user were a chef, or if the checklist package 224 is prompted by the user to provide more details on how to prepare the bread and/or peanut butter, the granularity of the checklist items may include an appropriate level of detail. The level of granularity of the checklist may also be determined by the checklist package 224 based on previous usage of the system by the user, user preferences, and/or data pulled from social media.

The preferences engine 654 of the DCAP, to be described below with respect to FIG. 2B, may determine the preferred networked device to which the checklist is to be transmitted. For example, to allow the user to execute the items on the checklist in a hands-free manner, the preferred device may be the user's smart glass.

In some implementations, the recognition package 226 may be called to distinguish a feature from a provided data signal. For example, the data signal may include one or multiple images captured of an object in the visible, infrared, and/or ultraviolet regions of the electromagnetic spectrum and sent by the user to the DCAP 130. Upon determination by the recognition package 226 that the correct object has been located, the checklist package 224 may be called to provide the appropriate checklist for performing on the object.

In some implementations, the data signal may be an infrared image used by the recognition package 226 to identify locations on the object that are emitting heat, or locations on the object that have abnormally high or low temperatures. In cases where an abnormal temperature location is identified by the recognition package 226, the checklist 224 may be called to provide a diagnostic checklist that addresses the abnormalities and/or a graphical representation of the abnormalities, for example, with respect to a baseline or other parameters.

In some implementations, the data signal may be an audio signal, and the recognition package 226 may be called to identify a sound from the audio signal that may indicate a problem with a piece of machinery. For example, if the machinery is generating noise in a certain frequency range, it may be an indication of a particular ball bearing fault in the machinery. Depending on the identified fault, the checklist 224 may be called to provide a checklist directed toward troubleshooting the identified fault.

In some implementations, the data signal may be based upon sensor data, such as temperature data or any other type of data sensed by a sensor. The recognition package 226 may analyze the data signal and provide a checklist based on the data signal.

The supporting information package 225 may be called to provide additional supporting information for a particular task on the checklist, for example, when the user does not understand how to perform the task, or when the user is having difficulty with successfully performing the task. In some implementations, the supporting information package 225 may be called upon a verbal request made by the user to the DCAP via the user's networked device, for example, the smart glass. For instance, the user may request a video applicable to the checklist item by using a predetermined voice command. The learning engine 640 of the DCAP, to be described below with respect to FIG. 2B, may determine the experience level of the user and provide an appropriate video in response to the information request.

The resource management package 227 may be called to certify a person as an expert resource for a checklist item on a checklist provided by the checklist package 224. Certification may include determining a level of experience of the person and a subject matter for which the person is experienced. For example, resource management package 227 may determine this information through testing or through previous experience where the person performed checklists provided by the DCAP checklist experience. Further, the resource management package 227 may be called to receive an availability schedule for the certified person. For example, the certified person may sign up to be on call for certain blocks of time as the expert resource for the checklist item for which the expert resource is certified.

Additionally, the resource management package 227 may be called to, upon receiving a request from a user for help with a checklist item, identify an available expert resource at a time of the request, and facilitate a connection, for example, a video streaming or remote viewing connection, between the expert resource and the user. In some implementations, the expert resource may have a network connection to receive a real-time video streamed by one of the user's networked devices, such as a smart glass, via the resource management package 227 and an audio/video streaming package 228, where the audio/video streaming package 228 facilitates streaming of audio and/or video from the end user to the remote expert. Further, audio and/or video from the expert resource may be sent to the user's networked device via the audio/video streaming package 228 in conjunction with the resource management package 227.

In some implementations, the resource management package 227 may operate in conjunction with the schedule package 220 and the checklist package 224 to ensure that there is an expert resource available to cover each item on the checklist during a given schedule.

Thus, for the example of FIG. 2A, experiences that may be provided to a user 201 may include any of the following: providing to the user a schedule that includes a time and a corresponding location for each schedule item on the schedule; providing turn-by-turn directions to the location of an item on the schedule; determining whether the user has crossed a geoboundary for the location of a schedule item; notifying the user upon arrival at the location of the item on the schedule; providing a context-aware checklist of items to be performed at the location, where the level of granularity of the checklist items is based on a determined experience level of the user; upon request from a user for information pertaining to one of the items of the checklist, calling a supporting information package to provide information to the user, where the information is selected based on the experience level of the user; determining whether an image from the user corresponds to an object on which the checklist is to be executed; determining a problem with the object based on audio data; certifying a person as an expert resource for a checklist item on the checklist, where certification includes determining a level of experience of the person; and identifying an available expert resource at the time of a request for help from the user; and facilitating a connection between the expert resource and the user.

FIG. 2B depicts a block diagram of example components of an example digital context-aware platform (DCAP) 130. The DCAP 130 may determine which package among multiple available packages 220-228 (collectively, packages 620) to execute based on information provided by the context engine 656 and the sequence engine 658. In some examples, the context engine 656 may be provided with information from a device/service rating engine 650, a policy/regulatory engine 652, and/or preferences engine 654. For example, the context engine 656 may determine which package to execute based on a device/service rating engine 650 (e.g., hardware and/or program instructions that can provide a rating for devices and/or services based on whether or not a device can adequately perform the requested function, such as the preferred networked device of a plurality of networked devices 110 of the user for which a checklist is generated), a policy/regulatory engine 652 (e.g., hardware and/or program instructions that can provide a rating based on policies and/or regulations, such as relating to privacy issues), preferences engine 654 (e.g., explicit preferences provided by a user, such as to which one of the user's networked device a checklist should be sent), or any combination thereof.

Preferences engine 654 may represent any circuitry or combination of circuitry and executable instructions to receive explicit preferences of a user. For example, a checklist user may explicitly provide preferences to the preferences engine 654 about the preferred networked device the user wants to use under particular conditions, for example, the device for receiving outdoor directions, indoor directions, and a checklist.

In some implementations, preferences engine 654 may search social media to determine a checklist user's capabilities, such as may be posted by the user on a website. In some implementations, preferences engine 654 may call an external service, for example services 670, to request that a social media searching service perform the social media search and return the results.

In addition, the sequence engine 658 may communicate with the context engine 656 to identify packages 620 to execute, and to determine an order of execution for the packages 620. In some examples, the context engine 656 may obtain information from the device/service rating engine 650, the policy/regulatory engine 652, and/or preferences engine 654 automatically (e.g., without any input from a user) and may determine which of packages 620 to execute automatically (e.g., without any input from a user). In addition, the context engine 656 may determine which of packages 620 to execute based on the sequence engine 658.

In some implementations, providing a checklist experience 610 to a user may include calling the schedule package 220 to provide to the user a schedule which includes a time and a corresponding location for each schedule item on the schedule; calling the outdoor navigation package 221 to provide turn-by-turn directions to a location on the schedule; calling the indoor navigation package 222 to provide directions within an indoor site of the location; calling the geoboundary package 223 to determine whether the user is within a geoboundary of a location of a schedule item; and calling the checklist package 224 to provide a checklist of items to be performed at the location on the schedule. Further, providing a checklist experience 610 to the user may include calling the supporting information package 225 to provide to the user information pertaining to one of the items of the checklist. The user may specify a type of information requested, such as videos, schematics, and instructions. In some implementations, the learning engine 640 may determine the skill level of a user and which specific information is most applicable to the user executing the checklist step based on characteristics of the user, such as experience level, and also based on learning from prior executions of the checklist step by the user.

Additionally, providing a checklist experience 610 to the user may include calling the recognition package 226 to determine whether an image signal provided by the user corresponds to an object on which the checklist is to be executed at the first location, or to determine a problem with the object based on audio data; and calling the resource management package 227 to identify an available expert resource at the time of a user's request, and to facilitate a connection between the expert resource and the user via the audio/video streaming package 228.

The checklist experience 610 may be initiated by the user via the user's networked device which communicates with the DCAP system 130 via network 105 (as shown in FIG. 1).

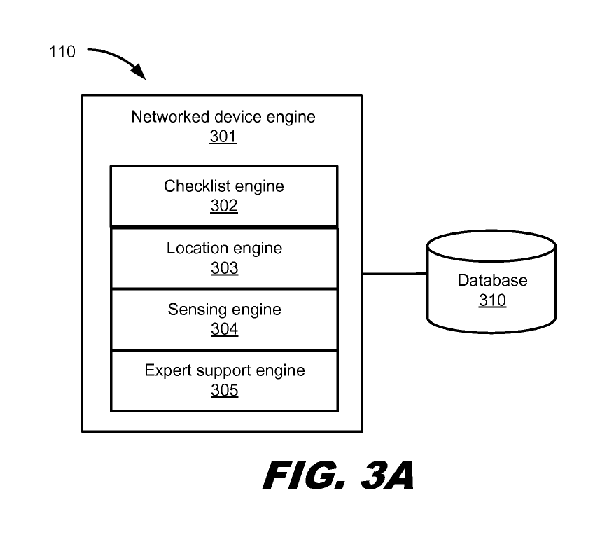

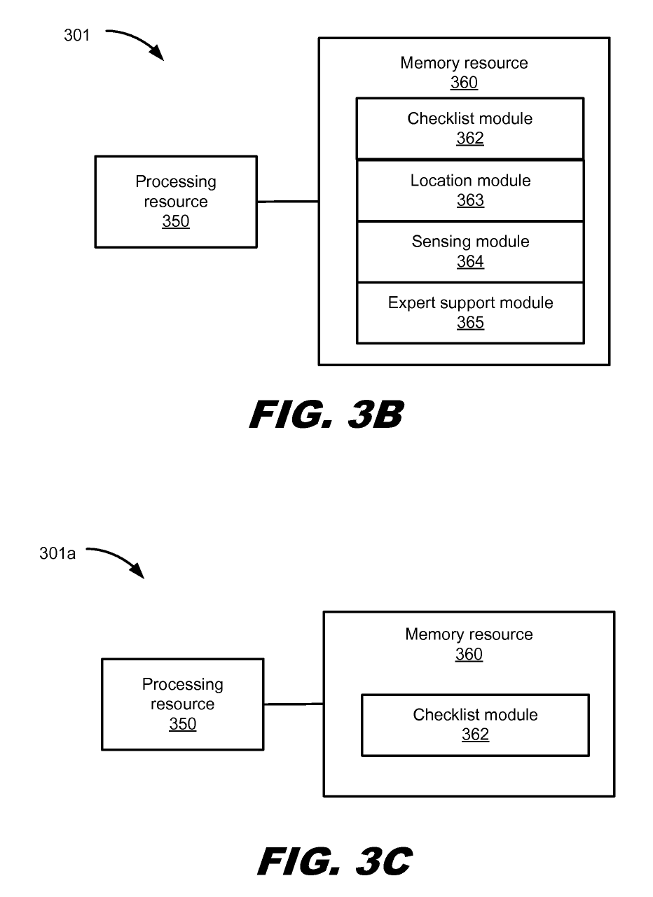

FIG. 3A depicts a block diagram of example components of a networked device 110 through which a user may request and receive a schedule, checklist and additional information pertaining to steps of the checklist from a DCAP 130. The networked device 110 may include a networked device engine 301 and a database 310. The networked device engine 301 may include a checklist engine 302, a location engine 303, a sensing engine 304, and an expert support engine 305. Each of the engines 302-305 may access and be in communication with a database 310 and with other networked devices 110.

Checklist engine 302 may represent any circuitry or combination of circuitry and executable instructions to receive a checklist of items to be performed at a first location upon crossing a geoboundary for the first location. The checklist engine 302 may also, based on input from a user, request from a DCAP 130 additional information pertaining to one of the items of the checklist, receive the information, and provide the information to the user. In some implementations, the checklist engine 302 may transmit the received information to another one of the user's networked devices 110 for providing to the user, for example, if the power supply of the networked device is running low, or if the user prefers to receive the information on a different networked device.

Location engine 303 may represent any circuitry or combination of circuitry and executable instructions to transmit an initialization request for the checklist to the DCAP. The location engine 303 may also receive turn-by-turn directions to a location listed on a schedule upon transmitting location coordinates to the DCAP 130 and continually updating the location coordinates.

The sensing engine 304 may represent any circuitry or combination of circuitry and executable instructions to provide a data signal to the DCAP 130, and receive any responses from the DCAP 130 to the data signal. For example, in some implementations, the data signal may include an infrared image, and the checklist provided by the DCAP may be based on an analysis of the infrared image. The sensing engine 304 may also provide an audio data signal from the first location to the DCAP 130, and the checklist provided by the DCAP 130 may be based on an analysis of the audio data. In some implementations, the data signal may be based upon sensor data, and the sensing engine 304 may provide the data signal to the DCAP 130, and the checklist provided by the DCAP 130 may be based on analysis of the sensor data.

The expert support engine 305 may represent any circuitry or combination of circuitry and executable instructions to, based upon input from a user, provide video taken of a portion of the first location to the DCAP for transmission to a certified expert for help with an item of the checklist. The expert support engine 305 may also receive guidance from the certified expert for the item. In some implementations, the video may be received from a second networked device; for example, the networked device may be a smartphone, while the video may be captured by a smart glass and sent to the smartphone for transmission to the DCAP.

Database 310 may contain information used by engines 302-305, such as a schedule and checklist received from the DCAP, images and/or audio data transmitted to an expert resource via the DCAP, and additional information received from the DCAP as requested by the user and pertaining to one of the checklist items.

The examples of engines, such as shown in FIG. 3A, are not limiting, as the described engines may be combined or may be a sub-engine of another engine. Further, the engines shown can be remote from one another in a distributed computing environment, cloud computing environment, etc.

Various components in the networked device 110 of FIG. 3A, may be combinations of hardware and program instructions and implemented in different ways. Referring to FIG. 3B, the programming may be processor executable instructions stored on tangible memory resource 360 and the hardware may include processing resource 350 for executing those instructions. Thus, memory resource 360 may store program instructions that when executed by processing resource 350, implements certain functions of the networked device engine 301 of FIG. 3A.

Memory resource 360 generally represents any number of memory components capable of storing instructions that can be executed by processing resource 350. Memory resource 360 is non-transitory in the sense that it does not encompass a transitory signal but instead is made up of one or more memory components configured to store the relevant instructions. Memory resource 360 may be implemented in a single device or distributed across devices. Likewise, processing resource 350 represents any number of processors capable of executing instructions stored by memory resource 360, respectively. Processing resource 350 may be integrated in a single device or distributed across devices. Further, memory resource 360 may be fully or partially integrated in the same device as processing resource 350, or it may be separate but accessible to that device and processing resource 350.

In one example, the program instructions can be part of an installation package that when installed can be executed by processing resource 350 to implement networked device engine 301. In this case, memory resource 360 may be a portable computer-readable medium such as a compact disc (CD), digital video disc (DVD), or flash drive or a memory maintained by a server from which the installation package can be downloaded and installed. In another example, the program instructions may be part of an application or applications already installed. Memory resource 360 can include integrated memory, such as a hard drive, solid state drive, or the like.

In the example of FIG. 3B, the executable program instructions stored in memory resource 360 are depicted as checklist module 362, location module 363, sensing module 364, and expert support module 365. Checklist module 362 represents program instructions that when executed cause processing resource 350 to implement checklist engine 302. Location module 363 represents program instructions that when executed cause processing resource 350 to implement location engine 303. Sensing module 364 represents program instructions that when executed cause processing resource 350 to implement sensing engine 304. Expert support module 365 represents program instructions that when executed cause processing resource 350 to implement expert support engine 305.

In some implementations of a networked device engine 301a, as shown in the example of FIG. 3C, the executable program instructions stored in memory resource 360 may include the checklist module 362, where the checklist module 362 represents program instructions that when executed cause processing resource 350 to implement checklist engine 302.

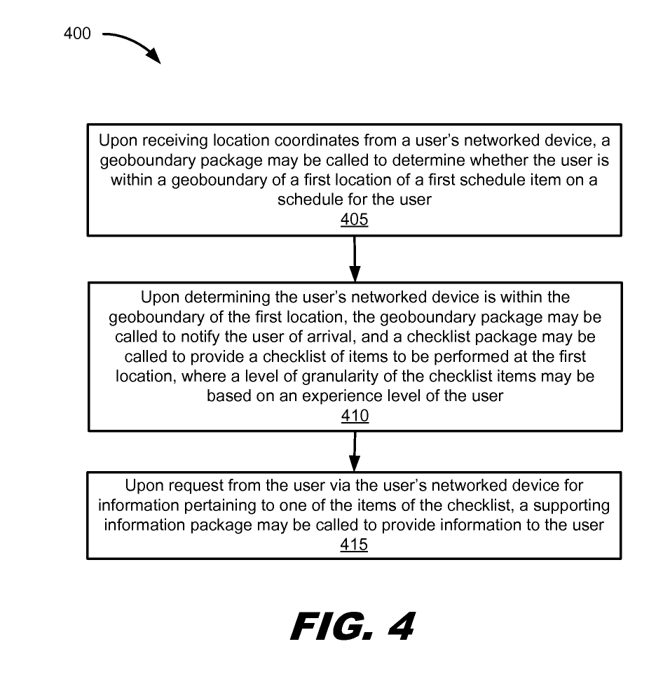

FIG. 4 depicts a flow diagram illustrating an example process 400 of providing a context-aware checklist experience to a user. The process begins at block 405 where the DCAP, upon receiving location coordinates from a user's networked device, may call a geoboundary package to determine whether the user is within a geoboundary of a first location of a first schedule item on a schedule for the user.

At block 410, the DCAP, upon determining the user's networked device is within the geoboundary of the first location, may call the geoboundary package to notify the user of arrival, and may call a checklist package to provide a checklist of items to be performed at the first location. A level of granularity of the checklist items may be based on an experience level of the user.

At block 415, the DCAP, upon request from the user via the user's networked device for information pertaining to one of the items of the checklist, may call a supporting information package to provide information to the user. The information may be selected based on the experience level of the user. In some implementations, the user may specify a type of information requested. Example of types of information that may be requested include videos, schematics, and instructions.

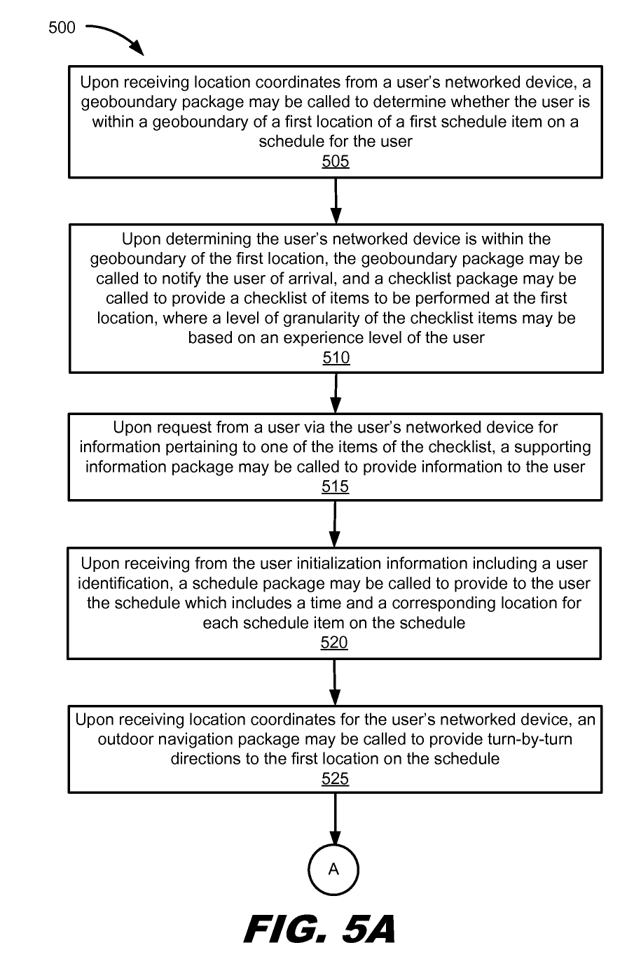

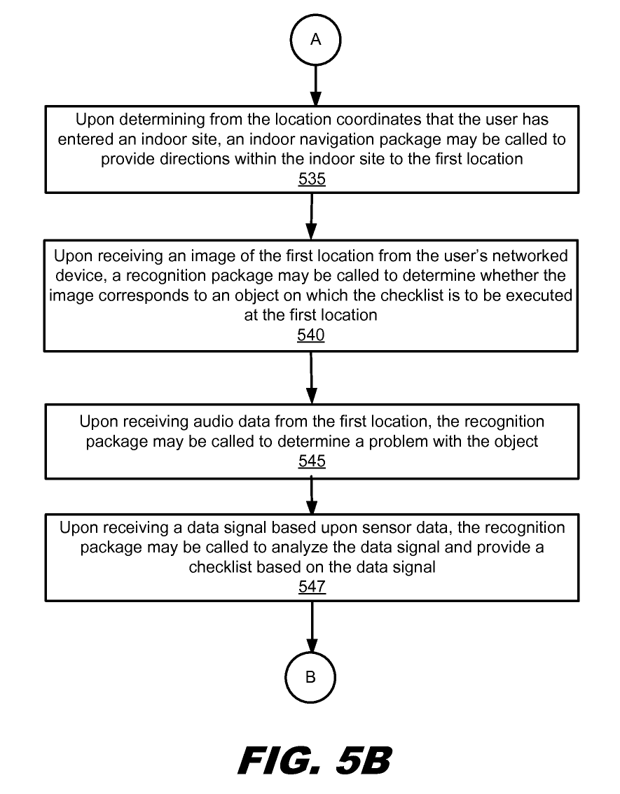

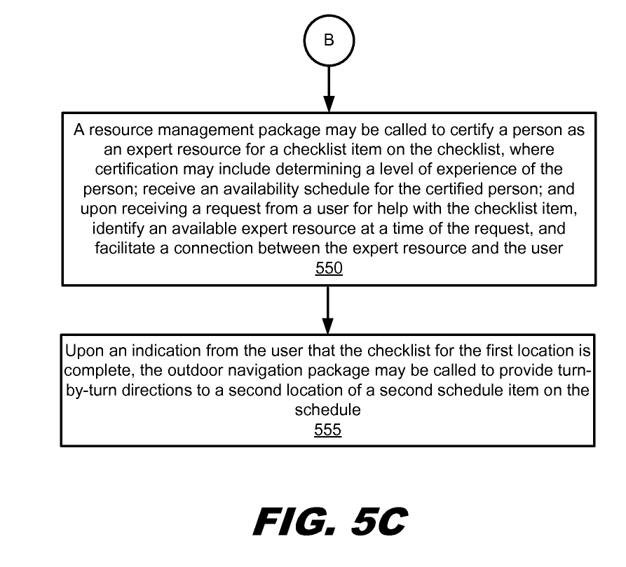

FIGS. 5A-5C depict a flow diagram illustrating an example process 500 of providing a digital context-aware checklist experience to a user. The process begins at block 505 which may be similar to block 405 described with respect to the process 400 of FIG. 4. Blocks 510 and 515 may also be similar to blocks 410 and 415, respectively, of FIG. 4.

At block 520, the DCAP, upon receiving from the user initialization information including a user identification, may call a schedule package to provide to the user the schedule that includes a time and a corresponding location for each schedule item on the schedule. User identification may be used by the DCAP to determine an experience level of the user.

At block 525, the DCAP, upon receiving location coordinates for the user's networked device, may call an outdoor navigation package to provide turn-by-turn directions to the first location on the schedule. For example, the location coordinates may be GPS coordinates.

At block 535, the DCAP, upon determining from the location coordinates that the user has entered an indoor site, may call an indoor navigation package to provide directions within the indoor site to the first location. For example, the directions within the indoor site may include direction to the particular floor and wing of the first location, and whether the location is on the right or left side of a corridor.

At block 540, the DCAP, upon receiving a data signal that includes an image of the first location from the user's networked device, may call a recognition package to determine whether the image corresponds to an object on which the checklist is to be executed at the first location. This information provides confirmation to the user that the checklist is performed on the intended object.

At block 545, the DCAP, upon receiving a data signal that includes audio data from the first location, may call the recognition package to analyze the audio data to determine a problem with the object. If a problem is detected from the audio data, a checklist is selected that addresses the identified problem.

At block 547, the DCAP, upon receiving a data signal based upon sensor data, may call the recognition package to analyze the data signal and provide a checklist based on the data signal.

At block 550, a resource management package may be called to certify a person as an expert resource for a checklist item on the checklist, where certification includes identifying a level of experience of the person; and to receive an availability schedule for the certified person. The resource management package may also be called to, upon receiving a request from a user for help with a checklist item, identify an available expert resource at a time of the request, and facilitate a connection between the expert resource and the user.

At block 555, the DCAP, upon an indication from the user that the checklist for the first location is complete, may call the outdoor navigation package to provide turn-by-turn directions to a second location of a second schedule item on the schedule.

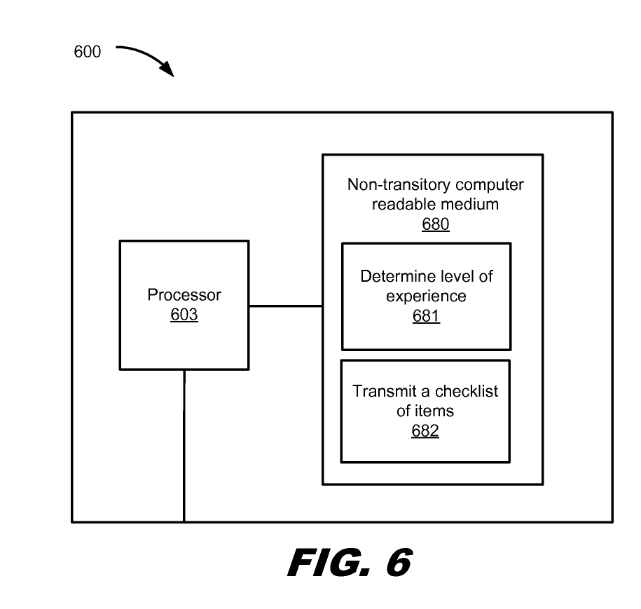

FIG. 6 illustrates an example system 600 including a processor 603 and non-transitory computer readable medium 680 according to the present disclosure. For example, the system 600 may be an implementation of an example system such DCAP 130 of FIG. 1.

The processor 603 may execute instructions stored on the non-transitory computer readable medium 680. For example, the non-transitory computer readable medium 680 may be any type of volatile or non-volatile memory or storage, such as random access memory (RAM), flash memory, or a hard disk. When executed, the instructions can cause the processor 603 to perform a method of determining a level of experience of a user and transmitting to the user a checklist of items appropriate to the level of experience of the user.

The example medium 680 can store instructions 681 executable by the processor 603 to receive information to be provided audibly to a user. For example, the processor 603 can execute instructions 681 to determine a level of experience of the user. For example, the level of experience of the user may be determined from the configuration of the user's role as set by a manager; the job code for the employee user; social media data; and/or history of the user's previous usage of the DCAP checklist experience.

The example medium 680 can further store instructions 682. The instructions may be executable by the processor 603 to transmit to the user a checklist of items. The granularity of the items on the checklist may be based on the level of experience of the user.

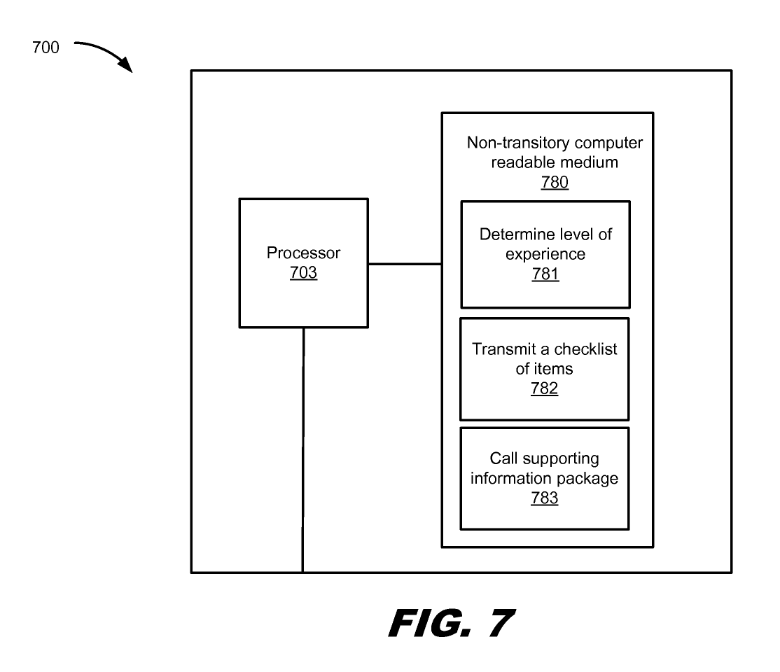

FIG. 7 illustrates an example system 700 including a processor 703 and non-transitory computer readable medium 780 according to the present disclosure. For example, the system 700 can be an implementation of an example system such as DCAP 130 of FIG. 1.

The processor 703 may execute instructions stored on the non-transitory computer readable medium 780. For example, the non-transitory computer readable medium 780 may be any type of volatile or non-volatile memory or storage, such as random access memory (RAM), flash memory, or a hard disk. When executed, the instructions can cause the processor 703 to perform a method of determining a level of experience of a user, transmitting to the user a checklist of items appropriate to the level of experience of the user, and calling a supporting information package to provide information for the level of experience of the user.

Instructions 781 may be similar to instructions 681 described with respect to the non-transitory computer readable medium 680 of FIG. 6. Instructions 782 may also be similar to instructions 682 of FIG. 6.

The example medium 780 may store instructions 783 executable by the processor 703 to call a supporting information package to provide additional information for a particular task on the checklist. The information selected to be provided may be based on the level of experience of the user.

Not all of the steps, features, or instructions presented above are used in each implementation of the presented techniques. Elements shown in the various figures described above can be added, exchanged, and/or eliminated so as to provide a number of additional examples of the present disclosure.

As used in the specification and claims herein, the singular forms “a,” “an,” and “the” include plural referents unless the context clearly dictates otherwise.

What is claimed is:

1. A method for providing a digital context-aware checklist comprising:
upon receiving location coordinates from a user's networked device, calling a geoboundary package to determine whether the user is within a geoboundary of a first location of a first schedule item on a schedule for the user;
upon determining the user's networked device is within the geoboundary of the first location, calling the geoboundary package to notify the user of arrival and calling a checklist package to provide a checklist of items to be performed at the first location, wherein a level of granularity of the checklist items is based on an experience level of the user;
upon request from the user via the user's networked device for information pertaining to one of the items of the checklist, calling a supporting information package to provide information to the user,
wherein the information is selected based on the experience level of the user.

2. The method of claim 1, wherein the user specifies a type of information requested, and types of information include videos, schematics, and instructions.

3. The method of claim 1, further comprising:
upon receiving from the user initialization information including a user identification, calling a schedule package to provide to the user the schedule which includes a time and a corresponding location for each schedule item on the schedule;
upon receiving location coordinates for the user's networked device, calling an outdoor navigation package to provide turn-by-turn directions to the first location on the schedule;
upon an indication from the user that the checklist for the first location is complete, calling the outdoor navigation package to provide turn-by-turn directions to a second location of a second schedule item on the schedule.

4. The method of claim 3, further comprising:
upon determining from the location coordinates that the user has entered an indoor site, calling an indoor navigation package to provide directions within the indoor site to the first location.

5. The method of claim 1, further comprising:
upon receiving an image of the first location from the user's networked device, calling a recognition package to determine whether the image corresponds to an object on which the checklist is to be executed at the first location;
upon receiving audio data from the first location, calling the recognition package to analyze the audio data and determine a problem with the object; or
upon receiving a data signal based upon sensor data, calling the recognition package to analyze the data signal and provide a checklist based upon the sensor data.

6. The method of claim 1, further comprising:
calling a resource management package to:
certify a person as an expert resource for a checklist item on the checklist, wherein certification includes determining a level of experience of the person;
receive an availability schedule for the certified person; and
upon receiving a request from a user for help with the checklist item, identify an available expert resource at a time of the request, and facilitate a connection between the expert resource and the user.

7. A non-transitory computer-readable medium having instructions stored thereon, the instructions executable by a processor of a digital context-aware platform (DCAP) comprising:
determining by a learning engine a level of experience of a user based upon a period of time for the user to complete a particular checklist and a rating on performance of the particular checklist by the user;
transmitting, to a networked device of the user, a checklist of items to be performed at a first location upon crossing a geoboundary for the first location, wherein a granularity of the checklist is based on the level of experience of the user.

8. The non-transitory computer-readable medium of claim 7, wherein the instructions are executable by the processor of the DCAP and further comprising:
upon request from the user for information pertaining to one of the items of the checklist, calling a supporting information package to provide supporting information, wherein the supporting information is selected for the level of experience of the user.

9. A system in a networked device comprising:
a processor; and
a memory including instructions executable by the processor to:
receive a checklist of items to be performed at a first location upon crossing a geoboundary for the first location;
based on input from a user, requesting from a digital context-aware platform (DCAP) information pertaining to one of the items of the checklist;
receiving the information; and
providing the information to the user.

10. The system of claim 9, wherein the memory includes instructions further executable by the processor to:
transmit an initialization request for the checklist to the DCAP; and
receive turn-by-turn directions to the first location listed on a schedule upon transmitting location coordinates to the DCAP and updating the location coordinates.

11. The system of claim 9, wherein the memory includes instructions further executable by the processor to:
provide an image of the first location to the DCAP;
receive confirmation whether the image includes a correct object upon which the checklist items are to be executed,
wherein the provided checklist is based on analysis of the image.

12. The system of claim 9, wherein the memory includes instructions further executable by the processor to:
provide audio data from the first location to the DCAP, wherein the provided checklist is based on analysis of the audio data.

13. The system of claim 9, wherein the memory includes instructions further executable by the processor to:
provide a data signal based upon sensor data to the DCAP, wherein the provided checklist is based upon analysis of the sensor data.

14. The system of claim 9, wherein the memory includes instructions further executable by the processor to:
based upon input from a user, provide video taken of a portion of the first location to the DCAP for transmission to a certified expert for help with an item of the checklist; and
receiving guidance from the certified expert for the item.

15. The system of claim 14, wherein the video is received from a second networked device.
